(19) United States
(12) Patent Application Publication
(10) Pub. No.: US 2021/0400989 A1
(43) Pub. Date: Dec. 30, 2021

(54) AGRICULTURAL PESTICIDE CONTAINING ALLIUM SATIVUM AND HELIOPSIS LONGIPES EXTRACTS

(71) Applicant: Beatriz FLORES SAMANIEGO, Celaya (MX)

(72) Inventor: Beatriz FLORES SAMANIEGO, Celaya (MX)

(21) Appl. No.: 17/279,355

(22) PCT Filed: Aug. 23, 2019
(86) PCT No.: PCT/MX2019/050018

§ 371 Date: Mar. 24, 2021

(30) Foreign Application Priority Data
Sep. 25, 2018 (MX) MX/A/2018/011681

(51) Int. Cl. A01N 65/42; A01N 65/12; A01N 25/30

(52) U.S. Cl. CPC A01N 65/42; A01N 25/30; A01N 65/12

(57) ABSTRACT

The present invention refers to an insecticidal composition based on natural extracts for control and/or elimination of pest insects in agricultural crops in greenhouse and/or in the field in general, characterized in that it comprises: a) 20%-80% of natural extract of Allium sativum; b) 20%-80% natural extract of Heliopsis longipes and c) 18% -10% of a surfactant; all of this must sum up to 100%.

The percentages of each component in the composition of the present invention provide a synergistic effect with greater effectiveness and a longer effect in combating pest insects, guaranteeing control of adults, nymphs, pupae, larvae, and eggs; especially of adults altering their eating and sexual behavior, causing paralysis and toxicity; especially in mites of agricultural importance of Acaridae, Eriophydae, Tenuipalpidae, Tetranychidae and Tarsonemidae families.

Garlic extract (Allium sativum), in its composition, has an effect on the nervous system of mites and insects in general, acting in synergy with the extract of Chilcuague (Heliopsis longipes). Chilcuague (Heliopsis longipes) extract has a paralyzing and toxic effect on mites and insects in general, mainly attacking adult populations.

The garlic extract (Allium sativum) is obtained by maceration method with settle, while the extract of chilcuague (Heliopsis longipes) is obtained by the solid-liquid extraction method with constant stirring. Both extracts are obtained using water or organic solvents and subsequently are combined and mixed with a surfactant.

### FIELD OF INVENTION

The present invention refers to an acaricidal composition prepared by means of a mixture of natural extracts of Allium sativum and Heliopsis longipes, for control and/or elimination of pest mites in agricultural crops, for use in greenhouses and/or in the field.

### BACKGROUND OF THE INVENTION

Mites constitute the most important group among the plague species of cultivated plants, after insects, representing between 15 and 20% of the pests with the greatest economic impact on crops. The most important agricultural species belong mainly to the families Acaridae, Eriophydae, Tenuipalpidae, Tetranychidae and Tarsonemidae.

Currently, to face the problems caused by pests, the agricultural producers resort to the use of chemical insecticides as the only alternative, however, the recurrent use of these products causes some undesirable effects such as damage to health, environmental contamination and resistance development and losses in biodiversity; affecting beneficial organism populations.

To address these problems, it is necessary to design pest management systems that consider the maintenance of biological balance and not the firmly established idea of “zero pests”, which can be achieved by integrating multiple control measures that preserve the environment and contribute to the production mode sustainability. Agroecological Pest Management is a recent response that seeks to reduce undesirable impacts by gradually eliminating the use of chemically synthesized insecticides. This management method includes the use of alternative treatments such as products of biological origin or plant extracts.

The use of plant extracts represents an economical and simple alternative to prepare, with a low environmental impact, the control of pests and diseases. Research on the use of plant extracts as a non-polluting option for pest control is expanding in several countries with very promising results. The extracts can act as insect repellants or be toxic.

An interesting plant to prepare natural extracts with insecticidal activity is garlic (Allium sativum), since it has repellent activity towards insects and animals, as well as fungicidal and antimicrobial activities. Garlic contains substances that alter insect behavior, interfering with their eating habits, sexual communication and altering the nervous system.

Another plant that shows interesting properties for pest management is the chilcuague (Azteca Gold Root) (Heliopsis longipes). This plant also has insecticidal and bactericidal activity, as well as having local anesthetic activity.

Considering the aforementioned phytosanitary problems, a new alternative arises of making a synergistic mixture with plant extracts, increasing the efficiency and biological activity of plant extracts such as garlic (Allium sativum) and chilcuague (Heliopsis longipes).

Documents ES2360447 and AR081884 describe an insect repellent preparation based on a garlic extract and humic acids mixture in a preferred ratio of 1:7. This invention differs substantially from the one presented, since in the present invention we are combining the garlic extract with an extract of H. longipes to achieve a specific control effect on mites.

Document U.S. Pat. No. 8,536,091B2 describes a system to control the growth of fungi and other plant pathogens using at least one alkamide derived from Heliopsis longipes, which does not affect the inventiveness of the present document, since our invention mixes extracts of H. longipes and A. sativum for specific control of pest mites in crops.

Document CN103222487 describes a composition based on Allium sativum, Allium cepa and Litsea cubeba for control of aphids in tobacco plants, which does not affect the inventiveness of our extract mixture of Allium sativum and Heliopsis longipes for control of mites in crops.

Document RO127369 describes an ant control composition by means of Allium sativum extract, which does not affect the invention of the present document for control of mites.

### DESCRIPTION OF THE INVENTION

The present invention refers to an acaricidal composition based on a plant extract mixture of Allium sativum and Heliopsis longipes, for control and/or elimination of pest mites in agricultural crops, for use in greenhouses and in the field in general; comprising:

a) A natural extract of Allium sativum;

b) A natural extract of Heliopsis longipes and

c) A surfactant

In a preferred embodiment, the pest mite control and/or elimination composition comprises:

a) 25 to 45% natural extract of Allium sativum

b) 45% to 65% natural extract of Heliopsis longipes and

c) 10% of a surfactant

Must sum in total 100%.

The surfactant is selected from a polyoxyethylene alcohol or a polyoxyethylene alkylphenol, and/or mixtures thereof.

The garlic extract (Allium sativum) in the composition works by protecting crops through its intervention in the insect metabolism and behavior, producing a masking effect of the pheromones produced by them and interfering with sexual communication and feeding, it acts also as a repellent by systemic action because it causes changes in the perspiration of the plant and also alters the insect nervous system due to its thiosulfate compounds.

Chilcuague (Heliopsis longipes) extract has insecticidal activity causing paralysis and toxicity against insects.

The percentages of each component in the composition of the present invention provide a synergistic effect with greater effectiveness and a longer effect in combating pest mites, guaranteeing control of adults, nymphs, pupae, larvae, and eggs; especially of adults altering their eating and sexual behavior, causing paralysis and toxicity.

### Chilcuague Generalities

Chilcuague (Heliopsis longipes S.F. Blake) is a perennial herb endemic to the Álvarez and Gorda mountains, a region where part of the territories of San Luis Potosi, Guanajuato and Quéretaro, Mexico coincide.

The genus Heliopsis belongs to the Heliantheae tribe of the Asteraceae family. This tribe comprises about 2,500 species grouped into 189 genera and is divided into ten subtribes, including Zinnia, Philactis, Sanvitalia, Acmella, Podachaenium, Squamopappus, Spilanthes and Salmea, which make up the Zinniinae subtribe. Its members share in their morphology the presence of solitary capitula, conical or hemispherical receptacles, persistent, fertile, pistillate ligulate flowers, fertile disc flowers, and laterally compressed or angulated disc achenes.

The leaf margin is an important feature. Most of the species have toothed or semi-toothed leaves, although some have them almost entirely or irregularly crenated. Leaf texture is generally firm, except for annual plants which have usually thin and fragile leaves.

### Alkamides in the Heliopsis Genus

Alkamides are formed by combining two different metabolic pathways. The acidic part originates from a fatty acid of medium to long chain length, which can be eight to eighteen carbons, generally aliphatic or linear; which when condensing with an amino acid and in concomitant decarboxylation, results in the production of an alkamide. The amides, whose acidic chain is aliphatic, depending on the unsaturated bonds type they present, can be separated into two groups: olefinic alkamides, with at least one double bond, and acetylenic alkamides, with at least one triple bond.

Only aliphatic and acetylenic alkamides have been found in the genus Heliopsis. Spilanthol is the alkamide responsible for the biological effects of chilcuague (which accumulates in its roots, in large quantities of up to 1% of the root total weight), among which are considered the local anesthetic, flavoring, insecticide and bactericide activity.

Allium sativum Extract Toxicity

Among the chemical compounds of garlic (Allium sativum), responsible for control and/or elimination of mites and pest insects in general, are mainly sulfur compounds such as alliin that in the presence of the allinase enzyme generates allicin, ajoene, s-allyl-cysteine, L-glutamic acid that becomes excitotoxin for insects and increases permeability to other substances and mainly thiosulfinates and diallylsulfide that act as repellants for insects and some animals.

Allium sativum Extract Obtaining

In one embodiment of the present invention, the process for obtaining a garlic extract is carried out as follows:

a) Selection and cleaning of bulbs by weight, size, and health condition.

b) Mill grinding to obtain pulp. For each kg of garlic, 500-1500 ml of water and 0.5-10 g of NaCl are added.

c) Extraction with water or any other organic solvent in a ratio of 0.5-2.5 L/kg garlic, keeping at settle for 20-30 days, stirring of 10-35 minutes every 2-5 hours.

d) Once the time has elapsed, the extract obtained is transferred to 20 L containers for storage.

Heliopsis longipes Extract Obtaining

In one embodiment of the present invention, the process for obtaining a chilcuague extract is carried out as follows:

a) Collection and selection of roots of H. longipes.

b) Drying and mill grinding until obtaining a fine powder.

c) Extraction with water or any other organic solvent in a ratio of 2-10 L/kg of chilcuague, with constant stirring for 18-30 hours at 35-45° C. temperature

d) Filtration of the extract using a filter press or any other filtration method to remove suspended particles.

e) Evaporation or distillation of the obtained extract at 35-55° C. temperature, until concentration.

f) Storage at 4° C. until use or addition of the extract to the desired mixture.

The present invention also relates to the methods of applying the composition, which can be spraying, atomizing, dispersing, coating, or pouring; depending on the expected results and the present circumstances, as well as the use of the composition for the control of pest mites of agronomic interest of Acaridae, Eriophydae, Tenuipalpidae, Tetranychidae and Tarsonemidae families.

1. An acaricidal composition based on natural extracts for control and/or elimination of pest insects in agricultural crops, characterized in that it comprises:
a) A natural extract of Allium sativum;
b) A natural extract of Heliopsis longipes and
c) A surfactant

2. A composition according to claim 1, characterized in that it comprises:
a) 20%-80% natural extract of Allium sativum;
b) 20%-80% natural extract of Heliopsis longipes;
c) 10%-18% of a surfactant
wherein the natural extract of Allium sativum, the natural extract of Heliopsis longipes and the surfactant comprises a sum total of 100%.

3. A composition according to claim 1, characterized in that the percentage corresponds to the percentage by volume.

4. (canceled)

5. A composition according to claim 1, characterized in that the composition is used for the control of mites of agricultural importance of Acaridae, Eriophydae, Tenuipalpidae, Tetranychidae and Tarsonemidae families.

6. A composition according to claim 1, characterized in that the composition is applied to greenhouse or open field crops, with doses of 1 to 3 L/hectare and an average efficiency of 70 to 90% is expected.

7. A composition according to claim 1, characterized in that the garlic extract (Allium sativum) has an effect of 40% mite mortality mainly attacking adult populations.

8. A composition according to claim 1, characterized in that the chilcuague (Heliopsis longipes) extract has an effect of 60% mite mortality.

9. A composition according to claim 1, characterized in that the active substance responsible for the biological effects of chilcuague is spilanthol alkamide.

10. (canceled)

11. A composition according to claim 6, characterized in that the mixture of extracts of chilcuague (Heliopsis longipes) and garlic (Allium sativum), has a mortality effect between 70 and 90% in mites of agricultural importance, showing a synergistic effect of both extracts in the mixture.

12. A composition according to claim 7, characterized in that the mixture of extracts of chilcuague (Heliopsis longipes) and garlic (Allium sativum), has a mortality effect between 70 and 90% in mites of agricultural importance, showing a synergistic effect of both extracts in the mixture.
